(19) United States
(12) Patent Application Publication
(10) Pub. No.: US 2007/0082541 A1
(43) Pub. Date: Apr. 12, 2007

(54) Clip for flat flexible cable

(76) Inventors: Michael J. Alloway, Canton, MI (US); Charles Heard, Detroit, MI (US); Gary Vettese, Sterling Heights, MI (US)

Correspondence Address: HONIGMAN MILLER SCHWARTZ & COHN LLP, 38500 WOODWARD AVENUE, SUITE 100, BLOOMFIELD HILLS, MI, 48304-5048, US

(21) Appl. No.: 11/230,435

(22) Filed: Sep. 20, 2005

(51) Int. Cl. H01R 12/24

(52) U.S. Cl. 439/492

(57) ABSTRACT

A retainer for a flat flexible cable includes a first closure portion having a top surface, a bottom surface and side surfaces, a second closure portion having a top surface, a bottom surface and side surfaces, and a hinge portion separating the first and second closure portions. At least one of the top surfaces includes a nib for frictionally engaging and positively securing a cable at a desired location when the clip is placed in a closed position.

### TECHNICAL FIELD

The present invention generally relates to a clip or retainer for a flat flexible cable, and in particular to a clip including one or more nibs protruding from first and second closure portions for frictional engaging and positively securing the clip to the cable at a desired location when the clip has been placed in a locked position.

### BACKGROUND OF THE INVENTION

Conventional methods for attaching wire harnesses to a vehicle body require a troublesome process for binding a wire harness retainer to the wire harness. Typically, the wire harness and the wire harness retainer are bound together by adhesives, tapes or the like. As a result, the location of The clip is not adjustable along the wire harness. Consequently, the wire harness and the wire harness retainer may not be properly aligned with the corresponding apertures in the vehicle body. The result is that the wire harness and the wire harness retainer may not be properly mounted to the vehicle body, or in some extreme cases, the wire harness and wire harness retainer may not be able to be mounted at all to the vehicle body.

### SUMMARY OF THE INVENTION

The inventors of the present invention have recognized these and other problems associated with the wire harness retainers. To this end, the inventors have invented a clip for a flat, flexible cable comprising a first closure portion having a top surface, a bottom surface and side surfaces, a second closure portion having a top surface, a bottom surface and side surfaces, and a hinge portion separating the first and second closure portions, wherein the top surfaces include at least one nib for frictionally engaging and positively securing a cable at a desired location when said clip is placed in a closed position.

### BRIEF DESCRIPTION OF THE DRAWINGS

FIG. 1 is a perspective view of a clip for receiving a flat flexible cable according to an embodiment of the invention when in a open position.

FIG. 2 is a side view of the clip when in the open position according to an embodiment of the invention.

FIG. 3 is an enlarged view of the circled area designated as 3 in FIG. 2.

FIG. 4 is a bottom view of the clip when in a closed position according to an embodiment of the invention.

### DETAILED DESCRIPTION

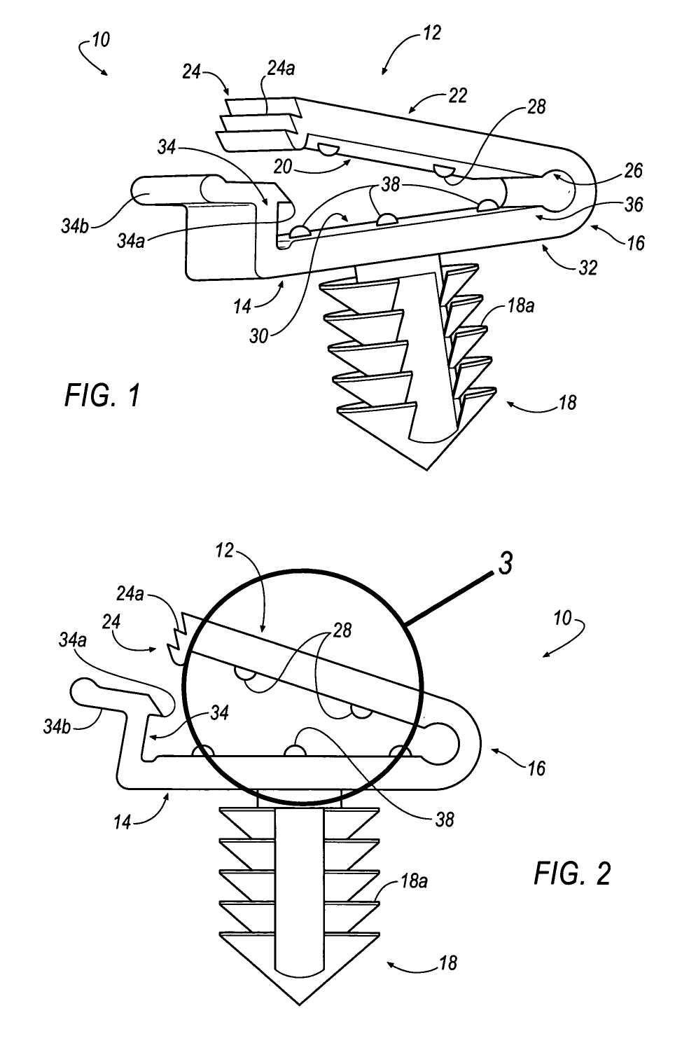

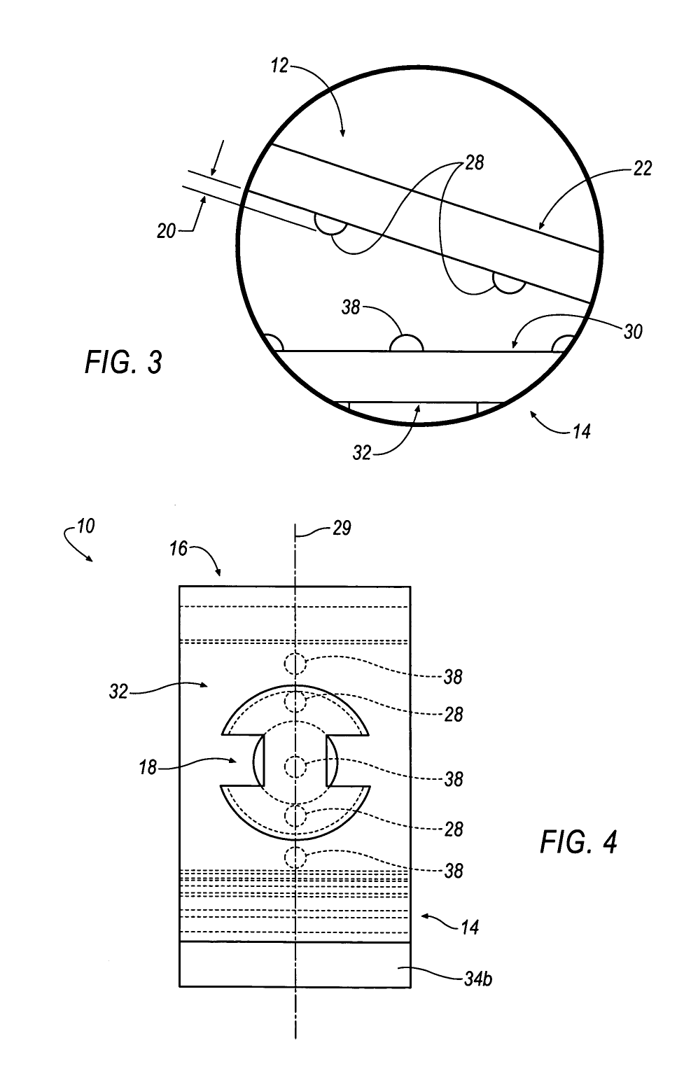

Referring to FIGS. 1-4, a retainer or clip for a flat flexible cable is generally shown at 10. In general, the clip 10 comprises a first closure portion 12 and a second closure 14 portion connected by a hinge portion 16. The hinge portion 16 may have a smaller thickness than the first and second closure portions 12, 14, thereby forming a living hinge, or the like, for allowing the first and second closure portions 12, 14 to hinge relative to one another. In the illustrated embodiment, the first closure portion 12, the second closure 14 and the hinge portion 16 are integrally formed as a single piece. The clip 10 may be formed from any number of materials, such as, for example, polyvinyl chloride, polypropylene, or the like.

As illustrated, the clip 10 also includes a retaining member 18 similar to a conventional “Christmas tree” retainer as is known in the art. The retaining member 18 comprises a plurality of truncated flat surfaces 18a generally forming the shape of a cone. It will be apparent to those skilled in the art that the retaining member 18 may be substituted with any other type of mounting clip, stud and other known equivalents can be used. For example, the retaining member 18 may comprise an adhesive, tape, or the like. In the illustrated embodiment, the retaining member 18 is centrally located on the second closure portion 14. However, it will be appreciated that the retaining member 18 can be located at any desired location on the clip 10, such as, for example, on the first closure portion 12.

The first closure portion 12 includes a top surface 20, a bottom surface 22 and side surfaces 24, 26. The top surface 20 includes one or more nibs 28 in the form of small semi-spherical shaped projections. In the illustrated embodiment, the top surface 20 includes a pair of nibs 28 that are substantially aligned along a central axis 29 of the clip 10, as shown in FIG. 4. However, the invention is not limited by the number or location of the nibs 28, and that the invention can be practiced with a lesser or greater number of nibs 28 that can be located at any position on the top surface 20. The side surface 24 includes one or more truncated flat surfaces 24a for cooperating with the second closure portion 14 to place the clip 10 in a closed position, as described in more detail below. In the illustrated embodiment, the side surface 24 includes three truncated flat surfaces 24a. However, the invention is not limited by the number of truncated flat surfaces 24a.

The second closure portion 14 includes a top surface 30, a bottom surface 32 and side surfaces 34, 36. Similar to the top surface 20, the top surface 30 includes one or more nibs 38 in the form of small semi-spherical shaped projections. In the illustrated embodiment, the top surface 30 includes three nibs 38 that are substantially aligned along the central axis 29 of the clip 10, as shown in FIG. 4. It should be noted that the nibs 28 of the first closure portion 12 are disposed between the nibs 38 of the second closure portion 14 along the central axis 29 of the clip 10. However, the invention is not limited by the number or location of the nibs 38, and that the invention can be practiced with a lesser or greater number of nibs 38 that can be located at any position on the top surface 30. For example, the nibs 28, 38 can be positioned offset from one another and not aligned along the central axis 29 of the clip 10. It should be noted that the nibs 28, 38 are spaced at an unequal distance from one another, i.e., the nibs 28, 38 are not equidistant to each other. However, the spacing between the nibs 28, 38 are such that, when the nibs 28, 38 engage a flat, flexible cable 50, the cable 50 forms an undulated profile when the clip 10 is placed in a closed position.

The side surface 34 includes at least one truncated flat surfaces 34a for cooperating and forming an interlocking relationship with the truncated flat surfaces 24a of the first closure portion 12 by hinging the clip 10 about the hinge portion 16 and snapping the truncated flat surface 34a into one of the truncated flat surfaces 24a to place the clip 10 in the closed position. In the illustrated embodiment, the side surface 34 includes one truncated flat surface 34a. However, the invention may be practiced with a greater number of truncated flat surfaces 34a, if desired. The side surface 34 may also include an outwardly extending tab 34b for causing the side surface 34 to flex when pressure is applied to the tab 34b by the user. In this manner, the clip 10 can be moved from a closed position in which the truncated flat surfaces 24a, 34a are in an interlocking relationship, and placed in an open position in which the truncated flat surfaces 24a, 34a are no longer in an interlocking relationship, as shown in FIGS. 1 and 2. In the illustrated embodiment, the truncated flat surfaces 24a, 34a extend along the entire length of the side surfaces 24, 34 of the clip 10, as shown in FIG. 1. However, it will be appreciated that the truncated flat surfaces 24a, 34a are not required to extend along the entire length of the side surfaces 24, 34.

In operation, a flat flexible cable 50 is placed on one of the first and second closure portions 12, 14 when the clip 10 is in an open position such that the clip 10 is placed at a desired location on the cable 50. Then, the first and second closure portions 12, 14 are hinged about the hinge portion 16 until the truncated flat surface 34a interlocks with one of the truncated flat surfaces 24a to snap together the first and second closure portions 12, 14 in an interlocking relationship to place the clip 10 in the closed position. When the clip 10 is in the closed position, the nibs 28 of the first closure portion 12 and the nibs 38 of the second closure portion 14 frictionally engage the cable 50 and prevent the cable 50 from movement relative to the clip 10. It will be appreciated that the first and second portions 12, 14 of the clip 10 have a sufficient width to allow the cable 50 to be placed on one of the first and second portions 12, 14 and hinged about the hinge portion 16 without interference by the cable 50.

The embodiments disclosed herein have been discussed for the purpose of familiarizing the reader with novel aspects of the invention. Although preferred embodiments of the invention have been shown and described, many changes, modifications and substitutions may be made by one having ordinary skill in the art without necessarily departing from the spirit and scope of the invention as described in the following claims.

1. A clip for a flat, flexible cable, comprising:
a first closure portion having a top surface, a bottom surface and side surfaces;
a second closure portion having a top surface, a bottom surface and side surfaces; and
a hinge portion separating the first and second closure portions,
wherein said top surfaces include at least one nib for frictionally engaging and positively securing a cable at a desired location when said clip is placed in a closed position.

2. The clip according to claim 1, further comprising a retaining member located on one of the first and second closure portions.

3. The clip according to claim 1, wherein said nibs are located along a central axis of said clip.

4. The clip according to claim 1, wherein one of said side surfaces of said first closure portion includes at least one truncated flat surface, and wherein one of said side surfaces of said second closure portion includes at least one truncated flat surface for cooperating with said at least one truncated flat surface of said first closure portion in an interlocking relationship to place said clip in a closed position.

5. The clip according to claim 4, wherein one of said first and second closure portions include an outwardly extending tab for placing said clip from the closed position to an open position.

6. The clip according to claim 1, wherein said nibs cause said cable to form an undulated profile when said clip is placed in the closed position.

7. The clip according to claim 1, wherein said nibs are semi-spherical in shape.
